(19) United States
(12) Patent Application Publication
(10) Pub. No.: US 2008/0163200 A1
(43) Pub. Date: Jul. 3, 2008

(54) Methods and systems for distributing software

(76) Inventors: Volker Schulz, Heppenheim (DE); Michael Dohle, Berlin (DE)

Correspondence Address: SAP / FINNEGAN, HENDERSON LLP, 901 NEW YORK AVENUE, NW, WASHINGTON, DC, 20001-4413, US

(21) Appl. No.: 11/647,142

(22) Filed: Dec. 29, 2006

(51) Int. Cl. G06F 9/445

(52) U.S. Cl. 717/177

(57) ABSTRACT

Systems and methods consistent with the invention relate to the distribution of software. According to one exemplary embodiment, a method for distributing software from a first system to a second system comprises determining a software object to be transported, where the software object is part of the software to be distributed. The method provides source information for the software object and creates, on the first system, a transport request which comprises an object list. The method defines, on the first system, a transport container and includes the source information for the software object in the transport container. The method also includes the transport container in the object list and provides the transport request to the second system.

### FIELD

The present invention relates to methods and systems for distributing software between systems. More particularly, the invention relates to methods and systems for distributing software that may comprise changes, including changes that may concern software components as well as data.

### BACKGROUND

Enterprises and organizations of any size often rely on software applications to conduct business. To meet the specific needs of such enterprises and organizations, the built-in functionality and predefined data of software components, and/or the data itself of a software application, may be changed. The process of changing software components and/or data is referred to as customization.

Customization of software components and/or data may usually not, however, be performed while the software system is running. Thus, enterprises may use at least two systems during customization. For instance, the customization may be initially carried out on the first system. This system may be denoted as the customization system. The second system, on the other hand, may be denoted as the productive system. In such an arrangement, changes are transported from the first system to the second system only after those changes have been successfully tested on the first system.

Other arrangements may use at least three systems—a customization system, a quality assurance system, and a productive system. Again, the customization system may be used to customize the applications. The quality assurance system, however, may be used to test the changes to determine that they work correctly. The changes are thus transported from the customization system to the quality assurance system and, then, from the quality assurance system to the productive system. The transport of changes from a first system to another system is referred to herein as software distribution.

Typically, enterprises and organizations use many different software applications. If these software applications are customized centrally on a customization system—for example by a team of administrators—a number of different applications may be distributed from the customization system to at least a further system. Normally, different software applications provide their own distribution tools. Therefore, a number of different distribution tools and distribution methods may be necessary to distribute different software applications. However, by using different distribution tools, there exists a higher risk of making mistakes during the software distribution process.

Accordingly, there exists a need to simplify the distribution of software and data involving different software applications.

### SUMMARY OF THE INVENTION

Systems and methods consistent with the invention relate to the distribution of software. According to one exemplary embodiment, a method for distributing software from a first system to a second system comprises determining a software object to be transported, where the software object is part of the software to be distributed. The method provides source information for the software object and creates, on the first system, a transport request which comprises an object list. The method defines, on the first system, a transport container and includes the source information for the software object in the transport container. The method also includes the transport container in the object list and provides the transport request to the second system.

Other objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 illustrates an exemplary embodiment of the invention comprising three systems;

FIG. 2 illustrates an exemplary implementation of the present invention;

FIG. 3 illustrates an exemplary flow diagram consistent with the present invention; and

FIG. 4 illustrates an exemplary export and import process consistent with the present invention.

### DESCRIPTION OF THE EMBODIMENTS

The following description refers to the accompanying drawings. Wherever possible, the same reference numbers will be used throughout the drawings to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

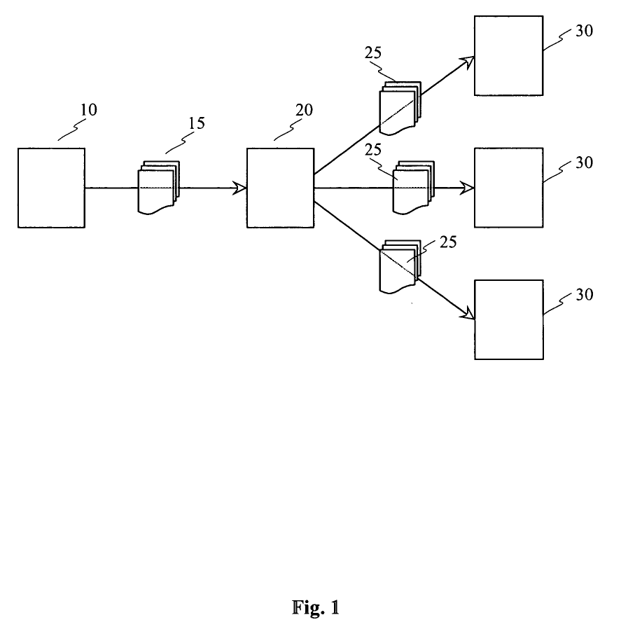

FIG. 1 illustrates an exemplary environment consistent with the invention. As shown in FIG. 1, an exemplary embodiment may include three systems 10, 20, an 30. Customization system 10 may be a system in which customization is initially made to a software application. Quality assurance system 20 may be a system in which the changes made in the customization system 10 are tested by using representative test data. Productive system 30 may be a system for normal business operations. Productive system 30 may thus be secure from any changes made in systems 10, 20 until those changes have been tested and are ready for transfer into productive system 30.

Each of systems 10, 20, 30 may represent a heterogeneous system which may comprise computer hardware and computer software. For example, the computer software may implement an enterprise relationship management system or a supply chain management system. Further, systems 10, 20, 30 may be connected by a communication network (not shown) such as an Ethernet, Wireless LAN or other appropriate network. In a further embodiment of the invention, only customization systems 10 and quality assurance system 20 may be connected by a communication network. In such an embodiment, productive system 30 may be separate from the systems 10, 20 for security reasons.

As shown in FIG. 1, productive system 30 may further comprise a plurality of computer hardware systems with the corresponding computer software. This may be necessary when a complex software system needs a separate database server, file server and application server (each not shown). Similarly, while not shown in FIG. 1, customization system 10 and quality assurance system 20 may also comprise a plurality of computer hardware systems and corresponding computer software systems.

As noted above, customization may take place on customization system 10. Customization may comprise, for example, developing new software applications, modifying existing software applications, developing new software modules, modifying existing software modules, generating new master data records and/or changing existing master data records. Further, customization may also comprise modifications to user master data and application data.

Systems 10, 20, and 30 may implement any type of software application. For instance, systems 10, 20, and 30 may include software applications such as native Windows™ applications, JAVA based applications and/or various database management systems. Software applications on systems 10, 20, and 30 may also comprise operating systems for common computer systems as well as operating systems for software controlled devices, such as industrial robots. Further, systems 10, 20, and 30 may include an entire software application or only a part of a software application. A software application or a part of a software application may be referred to as a software object. A software object may also contain master data, user data, application data and/or program code.

As shown in FIG. 1, all changes made in customization system 10 may be recorded to a change request file 15, and then transported to quality assurance system 20 for validation. In alternative embodiments, however, a complete software application containing the changes may be transferred between systems, as opposed to the use of a change request file 15. In any event, quality assurance system 20 may integrate the changes and check the validity and consistency of those changes before transferring them to productive system 30. All changes imported into quality assurance system 20 are then delivered (as illustrated by 25) to productive system 30. Thus, in quality assurance system 20, the functionality, e.g., the changes made in customization system 10, are tested without affecting the productive system 30.

A further embodiment of the invention may comprise only two systems, namely customization system 10 and productive system 30. In such an arrangement, customization system 10 may be used for customization as well as for quality assurance testing, and productive system 30 may be used for actual productive activities.

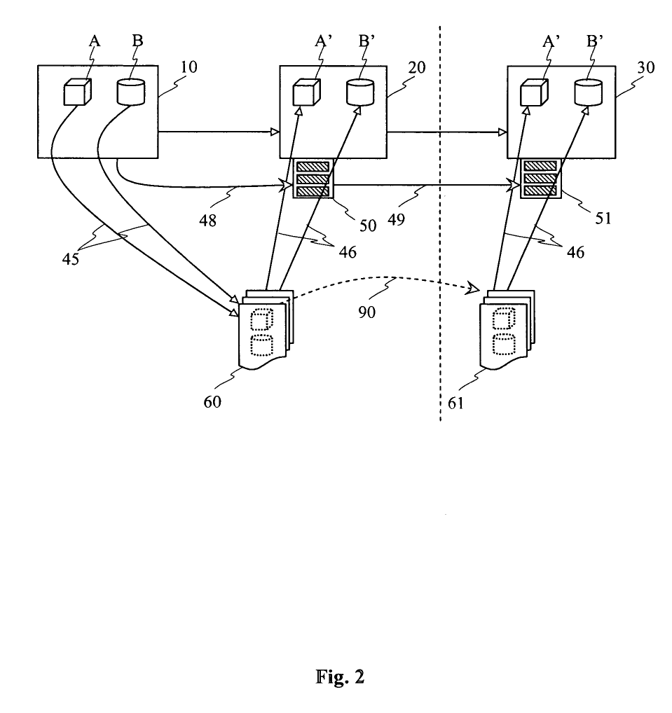

FIG. 2 illustrates an exemplary implementation of the present invention. As shown in FIG. 2, customization system 10 may be connected through a communication network to quality assurance system 20. Productive system 30 may be a system without any connection to systems 10 and 20. In FIG. 2, arrows between systems 10, 20 and 30 refer to a transportation route of the changes, e.g., changes are first transported from customization system 10 to quality assurance system 20 and then to productive system 30.

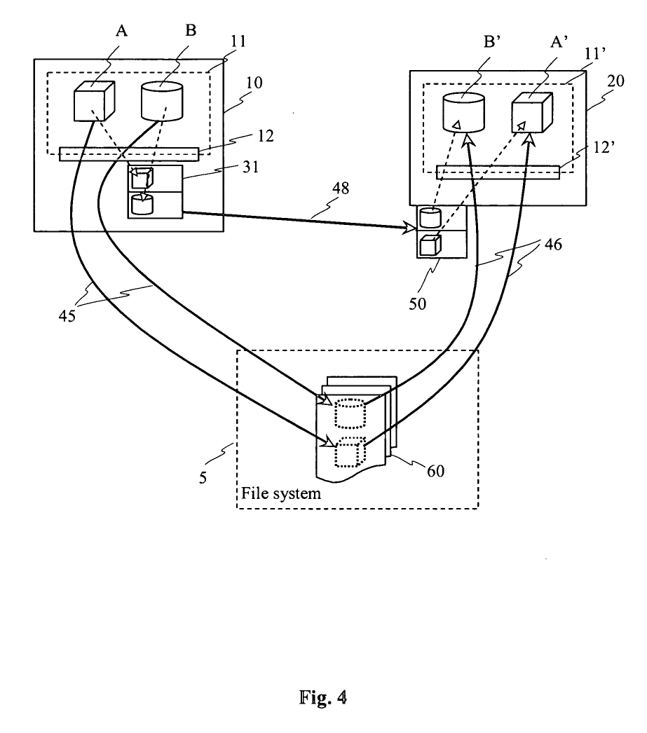

During a first phase, the software applications located on customization system 10 are customized. FIG. 2 illustrates two exemplary software applications, applications A and a database application B, which may be changed. In this example, application A and database application B each belong to the same software system, e.g. to a customer relationship management system. The applications A and B may, however, be developed by different companies. During the customization, a software module belonging to application A may be changed. Within database application B, new master data records may be inserted into the respective database. Furthermore, the database may also store software modules which belong to database application B. All these changes may be recorded by customization system 10 and stored within an object list. The object list may thus store information about the software modules to be transported. This information may also include information about the source location of the software modules. When the customization is done all the changes may then be released and exported. Releasing and exporting of changes is described more detail below with reference to FIG. 4.

During the export, changed software modules and/or master data records may be stored (as shown by arrow 45) into a data file 60 which may be located on a storage device. For the purpose of storing the software objects into data file 60, the export mechanism may evaluate the object list. As described above, the object list may provide information about the source location of the software modules to be transported. The source location may be one of a ‘stored in database’ and ‘stored on file system’ location. Considering this information, the export mechanism may copy the software modules and/or master data records from a database into the data file or from a file system into the data file. Thus, the export mechanism may create a single data file which may contain a plurality of software modules to be transported and/or a plurality of master data records to be transported.

Additionally, the object list may be transported (as shown by arrow 48) from customization system 10 into import buffer 50. Thus, in the exemplary embodiments, data file 60 may be not transported from system 10 to system 20. Data file 60 should, however, be accessible by both quality assurance system 20 and customization system 10.

During a second phase, the changes which have been imported into import buffer 50 may be imported into quality assurance system 20. As shown in FIG. 2, the software application A′ and the database B′ are updated with the software modules and/or master data records stored within data file 60. Finally, during the second phase, the imported components are tested in order to verify the requirements and the changes made on customization system 10. In a further embodiment of the present invention, prior to updating the software application A′ and B′ on quality assurance system 20, data file 60 may be expanded in order to store the software objects into the file system and to store the master data records into a database located on system 20.

Yet further, within the second phase, the verified changes are transported (shown as arrow 49) from the import buffer 50 to the import buffer 51 which belongs to productive system 30. If productive system 30 has no access to the storage device where data file 60 is stored, then data file 60 may be transported (as shown by arrow 90), e.g. by storage means such as compact discs (CD), digital versatile discs (DVD) or other means to productive system 30. The transport of data file 60 may also be carried out by a special software program which may be adapted for copying data files from a source location to a target location, whereby the special software program may have access to the source location and the target location. The transported data file is shown by item 61 in FIG. 2. The changes are then imported into productive system 30 as described above for quality assurance system 20.

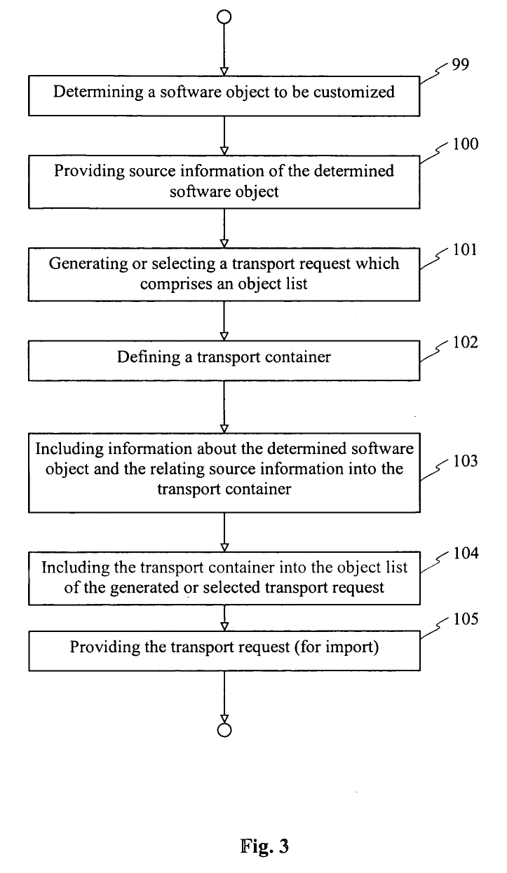

FIG. 3 illustrates an exemplary flow diagram relating to a software distribution process consistent with the present invention. For example, the process of FIG. 3 may be used as part of the first phase described above with reference to FIG. 2. During customization, software applications may be customized according to given requirements. As described above, customization may be performed on customization system 10. Systems consistent with the invention may record any changes made during customization to store those changes for future use or for transporting the customized software to different systems. Recording and storing changes may be necessary when a large number of developers are customizing the software application in parallel over a long period of time. After finishing the customization, the customized software objects may then be distributed by using the process of FIG. 3.

As shown in FIG. 3, the distribution system may determine a software object to be customized (step 99). This may be done for any software object to be customized. Therefore, step 99 may lead to a number of software objects which are to be customized and thus transported to quality assurance system 20.

Because systems consistent with the invention may transport a software object to systems other than a quality assurance system, however, the description below refers to the destination of a transported software objects as a target system. In FIG. 2, quality assurance system 20 is illustrated as the target system during phase two, while productive system 30 is illustrated as the target system during phase three.

The software objects to be transported may be located on different storage or processing sources of customization system 10. For example, master data records may be stored in a database management system, new software modules may be stored on a file system as well as in a database management system, and JAVA modules and applications may be stored as JAVA archives on the file system. Systems and methods consistent with the invention may, though, transport any type of software object, including .NET modules, irrespective of the storage or processing source.

The distribution system may then provide source information for the determined software objects (step 100). The source information may, for example, be one of ‘stored on file system’ and ‘stored in database’.

The distribution system may then generate a transport request or, if a transport request was already created before, select a transport request (step 101). A transport request may include an object list identifying the customized software objects, as well as header information containing, e.g., administrative information.

In one embodiment, a transport request may be created automatically for each software object to be transported. However, other embodiments may use an existing transport request. In any case, a user may request the generation of a new transport request for the software objects. Further, if there already exists a transport request containing a particular software object, the distribution system may automatically select that transport request and update the particular software object in the transport request with the corresponding changed software object.

The distribution system may then define or create a transport container (step 102). The transport container may hold a key of the software object to be transported and source information as described above. The key may be represented by a pointer to the respective software object. The key of the software object determined in processing step 100 may then be inserted into the created transport container (step 103). In one exemplary embodiment, each transport container may hold exactly one key. However, additional information about the software object to be transported may also be stored within the transport container, such as the type or size of software object. Thus, transport containers may hold information such as source location and/or key about different kinds of software objects, e.g. JAVA archives or .NET objects. Further, information about master data records may be stored within a transport container. If information about master data records coming from a data base are stored within the transport container the stored source location information may be ‘stored in database’ together with detailed description of data base, e.g. the instance of the data base, the source relation of the data record, etc.

Each created transport container may further comprise instructions specifying how the included software objects have to be handled during the distribution process. For example, the instructions may comprise methods or references to methods which are executed before the software objects are transported or copied into the data file. These methods may include compressing the software objects for the purpose of saving storage space or bandwidth of the communication network. Methods which are executed before the software objects are transported or exported are denoted as ‘before-export-methods’.

Furthermore, the instructions may also comprise methods which are executed after the software objects are imported into the target system. These methods may include, for example, decompressing the software objects. Methods which are executed after the software objects have been imported are denoted as ‘after-import-methods’. Generally, after-import-methods may also be used to activate the imported software objects within the target system.

Returning to FIG. 3, the distribution system may then include the transport container into the object list of the generated or selected transport request (step 104).

Finally, the transport request is provided for further use, e.g. for importing into the target system (step 105). The changes which have been performed during the customization are thus exported. The exporting may store the software objects in a single data file on a file system. A reference to the single data file may be created and inserted into the transport request. The file system may belong to the system where the changes have been made or may be an external file system or data storage device such as a DVD or CD. Thus, the data file may contain a number of different software objects, which, as described above, may be compressed before being copied into the data file.

In exemplary embodiments, processing step 105 may further include two sub-steps: locking the transport request, and exporting the software objects. As part of the locking sub-step, distribution systems consistent with the invention may lock the transport request, such that, e.g., the transport request cannot be changed anymore. As part of the exporting sub-step, systems consistent with the invention may copy, into the single data file, the software objects for which information is stored within the object list.

Providing the transport request may also include importing the transport request into the import buffer of the target system (see, e.g., arrow 48 and buffer 50 in FIG. 2). The data file may be shared by the source system and the target system.

FIG. 4 illustrates an exemplary export and import process consistent with the present invention. As described above, during customization, one or more software objects, such as software modules A and B, may be changed to meet given requirements. Software module A and database B may belong to a software application 11 which may be a Windows™ native application or a JAVA application or any further type of application. The software application 11 may provide an interface 12 which is adapted for passing the software module A and the changes on the database B to a data file 60 which is located with file system 5.

During customization, all changes to the software application may be recorded in an object list 31 which may have a number of transport containers. Each transport container may store information about exactly one software object to be transported from source system 10 to target system 20. As shown in the example of FIG. 4, object list 31 may store two transport containers. One transport container may relate to the software module A and the other transport container may relate to the database B. Further, the transport containers may store additional information about the source location and a key of the software objects. With respect to the example in FIG. 4, the transport container which belongs to software module A may hold information that module A is stored on the file system within source system 10. The transport container which belongs to database B may hold information that the software module B is stored within database B. The database B may also store master data records which have been changed during the customization process.

After releasing the changes, e.g., releasing the software objects to be transported from customization system 10 to quality assurance system 20, the software objects are exported 45 via interface 12 into the single data file 60 which is located on file system 5. The single data file 60 may be shared by both system 10 and system 20. When the software objects have been exported successfully, the transport request may be automatically added 48 to import buffer 50 of the target system 20. Thus, import buffer 50 may hold a list of transport containers which store information about the software objects 60 to be imported into target system 20. The stored information may also include information as to whether the software objects may be imported into the database or into the file system of target system 20. Due to security reasons, the import mechanism may be triggered manually.

During the import, the software objects which are stored with the single data file 60 are read and copied 46 into target system 20. For this purpose, software application 11′ which corresponds to source application 11 may provide an interface 12′ which is adapted for obtaining the software objects. Furthermore, interface 12′ may provide functionality for activating the imported software modules A′ and B′. The activating functionality may be one of the above mentioned after-import-methods. Further, an after-import-method may call an activating method provided by interface 12′. The software module A′ corresponds to the software module A. The database B′ corresponds to the database B.

As described above, database B may store master data records which may be changed during the customization step. Thus, copying software modules into target system 20 may comprise inserting master data records into a database B′.

Further, the distribution system may perform the after-import-methods as a last step of the import or after each imported software object. Finally, after the software objects have been imported and activated successfully, they may be deleted from import buffer 50. In a further embodiment of the invention, successfully imported software objects may be marked as “already imported” in order to prevent a further import of the objects.

For purposes of explanation only, certain aspects and embodiments are described herein with reference to the components illustrated in FIGS. 1-4. The functionality of the illustrated components may overlap, however, and may be present in a fewer or greater number of elements and components. Further, all or part of the functionality of the illustrated elements may co-exist or be distributed among several geographically dispersed locations. Moreover, embodiments, features, aspects and principles of the present invention may be implemented in various environments and are not limited to the illustrated environments.

Further, the sequences of events described in FIGS. 1-4 are exemplary and not intended to be limiting. Thus, other method steps may be used, and even with the methods depicted in FIGS. 1-4, the particular order of events may vary without departing from the scope of the present invention. Moreover, certain steps may not be present and additional steps may be implemented in FIGS. 1-4. Also, the processes described herein are not inherently related to any particular apparatus and may be implemented by any suitable combination of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for distributing software from a first system to a second system, comprising:
determining a software object to be transported, wherein the software object is part of the software to be distributed;
providing source information for the software object;
creating, on the first system, a transport request which comprises an object list;
defining, on the first system, a transport container;
including the source information for the software object in the transport container;
including the transport container in the object list; and
providing the transport request to the second system.

2. The method of claim 1, wherein the source information identifies a location where the software object is stored.

3. The method of claim 2, wherein the source information describes whether the software object is stored on a file system or a database.

4. The method of claim 3, wherein the file system and the database are part of the first system.

5. The method of claim 1, wherein the software object includes changes made at the first system.

6. The method of claim 1, wherein the transport container further includes:
instructions describing how the software object is to be handled during distribution of the software.

7. The method of claim 6, wherein the instructions describe a process executed before the software object is exported.

8. The method of claim 6, wherein the instructions describe a process executed after the software object is imported into the second system.

9. The method of claim 8, wherein the process executed after the software object is imported is provided via an interface by the second system.

10. The method of claim 1, wherein the software object is exported, and wherein exporting the software object further includes:
copying the software object from a database into a data file when the software object is stored in the database, and
copying the software object from a file system into a data file when the software object is stored on the file system.

11. The method of claim 10, wherein providing the transport request further includes:
exporting the transport request by storing the transport request in the data file.

12. The method of claim 10, further including providing an interface adapted to store the software object in the data file.

13. The method of claim 10, further including providing an interface adapted to obtain the software object stored in the data file and for activating the software object on the second system.

14. The method of claim 10, wherein the data file is shared by the first system and the second system.

15. The method of claim 1, further comprising creating an archive which contains the software object, whereby the archive is stored in the storage device.

16. The method of claim 15, wherein the archive is a JAVA runtime archive.

17. A system for distributing software from a first system to a second system, comprising:
a first module which determines a software object to be transported;
a second module which provides source information for the software object;
a third module which creates, on the first system, a transport request having an object list;
a fourth module which defines, on the first system, a transport container;
a fifth module for including the source information in the transport container;
a sixth module for including the transport container in the object list of the transport request; and
a seventh module which provides the transport request to the second system.

18. The system of claim 17, further comprising a module which creates a data file and stores the software object in the data file.

19. The system of claim 17, further comprising a module which transfers the transport request from the first system to the second system.

20. A method for distributing software from a first system to a second system, comprising:
identifying a software object to be transported;
generating, at the first system, a transport request including an object list that identifies the software object;
defining, at the first system, a transport container for the software object, wherein the transport container is included in the object list and includes source information for the software object; and
distributing the transport request to the second system.
